(19) United States
(12) Patent Application Publication
(10) Pub. No.: US 2026/0111167 A1
(43) Pub. Date: Apr. 23, 2026

(54) AUDIO PROCESSING SYSTEM, AUDIO PROCESSING METHOD, AND RECORDING MEDIUM ON WHICH AUDIO PROCESSING PROGRAM IS RECORDED

(71) Applicant: Sharp Kabushiki Kaisha, Osaka (JP)

(72) Inventor: Tatsuya NISHIO, Sakai City (JP)

(21) Appl. No.: 19/311,397

(22) Filed: Aug. 27, 2025

(30) Foreign Application Priority Data
Oct. 18, 2024 (JP) 2024-182468

(51) Int. Cl. G06F 3/16; H04R 3/12

(52) U.S. Cl. CPC G06F 3/165; G06F 3/167; H04R 3/12; H04R 2400/01; H04R 2420/07

(57) ABSTRACT

An audio processing apparatus includes an acquisition processing unit that acquires input sound input to a microphone of an audio device 2A among a plurality of audio devices 2 and a setting processing unit that, in a case where the input sound acquired by the acquisition processing unit is a registered sound registered in advance, changes a setting content of a predetermined setting item of the audio device 2A to a setting content registered in advance in association with the registered sound, and does not change a setting content of the predetermined setting item of audio devices 2B and 2C among the plurality of audio devices 2.

### INCORPORATION BY REFERENCE

This application is based upon and claims the benefit of priority from the corresponding Japanese Patent Application No. 2024-182468 filed on Oct. 18, 2024, the entire contents of which are incorporated herein by reference.

### BACKGROUND

The disclosure relates to a technique for controlling audio when a plurality of users individually use audio devices to have conversations.

In the related art, a system is known in which a plurality of users can have a conversation by using audio devices each of which includes a microphone and a speaker. For example, a system including a plurality of audio devices (personal communication devices) and a hub device that is installed in a conference space and allows the plurality of audio devices to connect simultaneously via a local network is known. The system enables a conversation using the audio devices, and can set a microphone of each audio device to mute in a case where a mute button provided in the hub device is pressed.

The known system has a configuration in which, in a hub device to which a plurality of audio devices are connected, all of the audio devices are muted together or unmuted together, and the plurality of audio devices cannot be muted or unmuted individually. Thus, in the known technology, it is difficult to individually change various settings for the plurality of audio devices, and there is a problem in that convenience is low.

### SUMMARY

An object of the disclosure is to provide an audio processing system, an audio processing method, and a recording medium on which an audio processing program is recorded that are capable of individually changing settings of a plurality of audio devices.

An audio processing system according to an aspect of the disclosure is a system that acquires input sounds input to respective microphones of a plurality of audio devices and executes predetermined audio processing. The audio processing system includes an acquisition processing unit and a setting processing unit. The acquisition processing unit acquires input sound input to a microphone of a first audio device among the plurality of audio devices. In a case where the input sound acquired by the acquisition processing unit is a registered sound registered in advance, the setting processing unit changes a setting content of a predetermined setting item of the first audio device to a setting content registered in advance in association with the registered sound, and does not change a setting content of the predetermined setting item of a different audio device among the plurality of audio devices excluding the first audio device.

An audio processing method according to another aspect of the disclosure is a method of acquiring input sounds input to respective microphones of a plurality of audio devices and executing predetermined audio processing. The audio processing method includes causing one or more processors to execute acquiring an input sound input to a microphone of a first audio device among the plurality of audio devices, and in a case where the acquired input sound is a registered sound registered in advance, changing a setting content of a predetermined setting item of the first audio device to a setting content registered in advance in association with the registered sound, and not changing a setting content of the predetermined setting item of a different audio device among the plurality of audio devices excluding the first audio device.

A recording medium according to another aspect of the disclosure is a recording medium on which a program that acquires input sounds input to respective microphones of a plurality of audio devices and executes predetermined audio processing is recorded. The audio processing program is a program for causing one or more processors to execute acquiring an input sound input to a microphone of a first audio device among the plurality of audio devices, and in a case where the acquired input sound is a registered sound registered in advance, changing a setting content of a predetermined setting item of the first audio device to a setting content registered in advance in association with the registered sound, and not changing a setting content of the predetermined setting item of a different audio device among the plurality of audio devices excluding the first audio device.

According to the disclosure, it is possible to provide an audio processing system, an audio processing method, and a recording medium on which an audio processing program is recorded that are capable of individually changing settings of a plurality of audio devices.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an application example of an audio processing system according to an embodiment of the disclosure.

FIG. 2 is a block diagram illustrating a configuration of the audio processing system according to the embodiment of the disclosure.

FIG. 3 is a diagram schematically illustrating an application example of an audio processing apparatus according to an embodiment of the disclosure.

FIG. 4 is a diagram illustrating an example of a setting information registration list stored in the audio processing apparatus according to an embodiment of the disclosure.

FIG. 5 is a flowchart for illustrating an example of a procedure of audio control processing performed in an audio processing apparatus according to Example 1 of the disclosure.

FIG. 6 is a flowchart for illustrating an example of a procedure of audio control processing performed in an audio processing apparatus according to Example 2 of the disclosure.

FIG. 7 is a flowchart for illustrating an example of a procedure of audio control processing performed in an audio processing apparatus according to Example 3 of the disclosure.

FIG. 8 is a flowchart for illustrating an example of a procedure of audio control processing performed in an audio processing apparatus according to Example 4 of the disclosure.

FIG. 9 is a flowchart for illustrating an example of a procedure of audio control processing performed in an audio processing apparatus according to Example 5 of the disclosure.

FIG. 10 is a diagram illustrating an example of a user information registration list stored in the audio processing apparatus according to Example 5 of the disclosure.

### DETAILED DESCRIPTION

Embodiments of the disclosure will be described below with reference to the drawings. Note that the following embodiments are specific examples of the disclosure, and do not limit the technical scope of the disclosure.

An audio processing system according to the disclosure can be applied to, for example, a case where a plurality of users in the same space (for example, a conference room) have conversations (conference) with users in other spaces by using respective audio devices each including a microphone and a speaker. Note that the audio processing system can also be applied to a case where a plurality of users each have a conversation using a respective audio device in one space. Furthermore, the audio processing system can also be applied to a case where one user in one space uses an audio device to have a conversation with a user in another space.

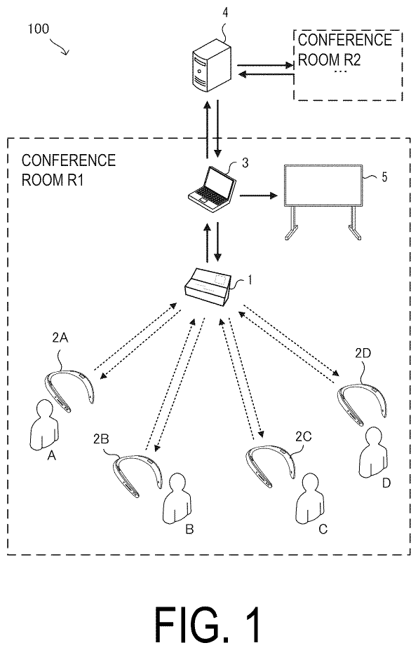

FIG. 1 illustrates an application example of an audio processing system 100 according to the present embodiment. As illustrated in FIG. 1, users A to D participate in a conference in a conference room R1, and other users (not illustrated) participate in the conference in a conference room R2. The users A to D have a conversation by respectively using neckband-type audio devices 2A to 2D each of which can be worn on the neck. The users in the conference room R2 may use audio devices 2, or may use one microphone speaker device installed in the conference room R2. The audio devices 2A to 2D may be audio devices of the same type or audio devices of different types. In addition, the audio devices 2A to 2D may be audio devices that include only a microphone and do not include a speaker. Furthermore, the audio devices 2A to 2D may be known general-purpose audio devices. For example, the audio device 2 may be a pin-type, gooseneck-type, hand-held-type, or desktop type microphone device.

Each of the audio devices 2 in the conference room R1 is wirelessly connected (connected via Bluetooth (trade name)) to the audio processing apparatus 1, and audio input to the microphone of each of the audio devices 2 is output (reproduced) from a speaker of the audio device 2 (or a microphone speaker device) of a user in the conference room R2 via a conference terminal 3 and a conference server 4 from the audio processing apparatus 1. Similarly, audio input to the microphone of the audio device 2 (or microphone speaker device) in the conference room R2 is reproduced from the speakers of the audio devices 2 of the respective users in the conference room R1 via the conference server 4, the conference terminal 3, and the audio processing apparatus 1.

As described above, the audio processing system 100 is a system that enables a plurality of users to have a conversation in the same space (the conference room R1 in FIG. 1) by individually using the audio devices 2. The audio processing system 100 may include a display device 5 that can be used in a conference. The conference application displays, on the display device 5, conference information such as camera images of the conference participants and conference materials, and recognition results (text information) acquired by converting audio into text by audio recognition processing.

As illustrated in FIG. 1, the audio processing system 100 includes the audio processing apparatus 1, the audio devices 2, the conference terminal 3, and the conference server 4. The audio device 2 is a wireless connection-based sound instrument equipped with a microphone and a speaker. Note that the audio device 2 may include, for example, a function such as an AI speaker or a smart speaker. The audio processing system 100 is a system that includes a plurality of audio devices 2 and transmits and receives audio data of uttered audio of users to and from the plurality of audio devices 2. The audio processing system 100 is an example of an audio processing system of the disclosure.

The audio processing apparatus 1 controls audio (input sound, output audio, and the like) to and from the audio devices 2, and performs processing of transmitting and receiving audio to and from the plurality of audio devices 2 when a conference is started in a conference room, for example. For example, the audio processing apparatus 1 controls the plurality of audio devices 2 arranged in the same space. In addition, the audio processing apparatus 1 accumulates audio acquired from the audio devices 2 as recording audio and performs processing (audio recognition processing) of converting the acquired audio into text. Note that the audio processing apparatus 1 alone may constitute the audio processing system of the disclosure.

Further, the audio processing system of the disclosure may include various servers that provide various services such as a conference service, a caption (transcription) service by audio recognition, a translation service, and a minutes service. In the present embodiment, the system includes the conference server 4 that provides the conference service. The conference server 4 provides an online meeting service of the conference application, which is one type of general-purpose software. For example, the conference application is installed in the conference terminal 3. Activating the conference terminal 3 for login enables execution of an online conference (for example, an online conference in the conference room R1 and the conference room R2) utilizing the conference application.

### Audio Processing Apparatus 1

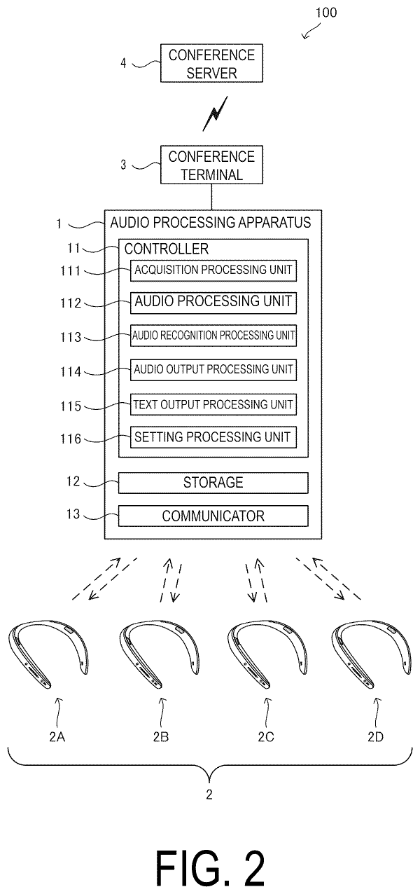

As illustrated in FIG. 2, the audio processing apparatus 1 is an instrument including a controller 11, a storage 12, and a communicator 13. For example, the audio processing apparatus 1 is connected to the plurality of audio devices 2 and constitutes equipment (for example, a mixer box) having a function of mixing or splitting audio input from the plurality of audio devices 2 or the conference terminal 3.

The communicator 13 connects the audio processing apparatus 1 to a communication network in a wired or wireless manner and executes data communication with external devices such as the audio devices 2 and the conference terminal 3 via the communication network in accordance with a predetermined communication protocol. For example, the communicator 13 performs pairing processing in accordance with the Bluetooth scheme to wirelessly connect to each audio device 2.

The storage 12 is a non-volatile storage such as a hard disk drive (HDD), a solid state drive (SSD), or flash memory that stores various types of information. Specifically, the storage 12 may store data such as information (a device number, a device ID, or the like) that can identify the audio device 2.

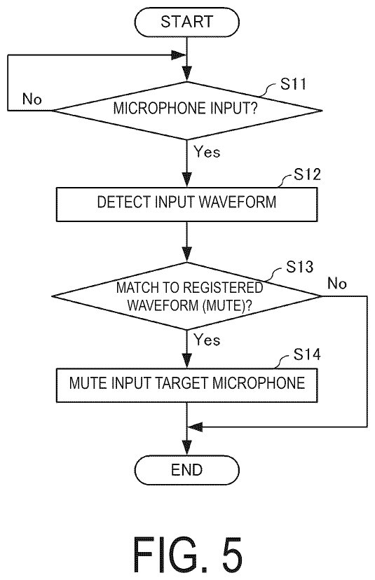

Further, the storage 12 stores control programs such as an audio control program (an example of the audio processing program of the disclosure) for causing the controller 11 to execute audio control processing described below (see FIGS. 5 to 9). For example, the audio control program may be recorded non-transitorily on a computer-readable recording medium such as a CD or a DVD, read by a reading device (not illustrated) such as a CD drive or a DVD drive included in the audio processing apparatus 1, and stored in the storage 12.

The controller 11 includes control devices such as a CPU, a ROM, and a RAM. The CPU is a processor that performs various types of arithmetic processing. The ROM is a non-volatile storage that stores, in advance, control programs such as a Basic Input/Output System (BIOS) and an Operating System (OS) for causing the CPU to perform various types of arithmetic processing. The RAM is a volatile or non-volatile storage that stores various types of information and is used as a temporary storage memory (work area) for the various types of processing performed by the CPU. Then, the controller 11 controls the audio processing apparatus 1 by causing the CPU to execute various types of the control programs stored in advance in the ROM or the storage 12.

Specifically, as illustrated in FIG. 2, the controller 11 includes various processing units such as an acquisition processing unit 111, an audio processing unit 112, an audio recognition processing unit 113, an audio output processing unit 114, a text output processing unit 115, and a setting processing unit 116. Note that the controller 11 functions as the various types of processing units by executing various types of processing in accordance with the control program using the CPU. Further, some or all of the processing units may be configured as electronic circuits. Note that the control programs may be programs for causing a plurality of processors to function as the processing units described above.

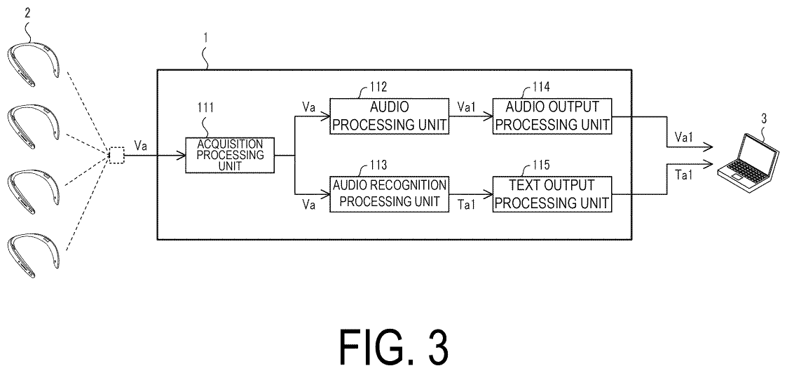

FIG. 3 schematically illustrates an example of the audio processing in a case where the audio processing apparatus 1 is applied to a conference. For example, when a conference is started and a user makes an utterance, the acquisition processing unit 111 acquires uttered audio (audio Va) input to the microphone of the audio device 2 of the user. The acquisition processing unit 111 performs routing processing for outputting the audio Va to a predetermined output destination. Here, the acquisition processing unit 111 outputs the acquired audio Va (audio data) to the audio processing unit 112 for generating audio for a conference and the audio recognition processing unit 113 for converting audio into text.

The audio processing unit 112 executes audio processing for reproducing audio from a speaker on the audio Va acquired by the acquisition processing unit 111. Specifically, the audio processing unit 112 executes at least one of echo cancellation (EC processing), noise cancellation (NC processing), and gain adjustment (AGC processing) on the audio Va. The audio processing unit 112 outputs the audio (audio Va1) subjected to the audio processing to the audio output processing unit 114.

The audio recognition processing unit 113 executes audio recognition processing for converting audio into text, based on the audio Va acquired by the acquisition processing unit 111. The audio recognition processing unit 113 converts audio into text using a predetermined audio recognition engine (trained model). The audio recognition engine is generated by learning various audio data (teacher data), and the audio data is data to which no audio processing such as echo cancellation, noise cancellation, or gain adjustment has been applied. The audio processing apparatus 1 is equipped with the audio recognition engine.

In this manner, the audio recognition processing unit 113 may execute the audio recognition processing based on the audio Va to which the audio processing has not been applied. The audio recognition processing unit 113 outputs a recognition result (text information Ta1) of the audio recognition processing for the audio Va to the text output processing unit 115.

The audio output processing unit 114 outputs the audio Va1 after the audio processing by the audio processing unit 112 to the conference terminal 3 in the conference room R1. The text output processing unit 115 outputs the recognition result (text information Ta1) of the audio recognition processing by the audio recognition processing unit 113 to the conference terminal 3 in the conference room R1.

The conference terminal 3 in the conference room R1 outputs the audio Va1 to the conference server 4 (see FIG. 1) when receiving the audio Va1 from the audio processing apparatus 1. The conference server 4 outputs the audio Va1 to the conference terminal 3 in the conference room R2 when receiving the audio Va1 from the conference terminal 3 in the conference room R1. The conference terminal 3 in the conference room R2 outputs the audio Va1 toward a user in the conference room R2.

Further, when the conference terminal 3 in the conference room R1 receives the text information Ta1 from the audio processing apparatus 1, the conference terminal 3 causes the display device 5 (see FIG. 1) to display the text information Ta1. In another embodiment, the conference terminal 3 may accumulate the text information Ta1 and create minutes of the conference. Further, the conference terminal 3 may cause user terminals (not shown) of respective users to display the text information Ta1.

As described above, the audio processing apparatus 1 acquires uttered audio of a user input to each audio device 2 and realizes conversation between users (such as an online conference) by performing transmission and reception of audio with the conference terminal 3 and each audio device 2. Here, the audio processing apparatus 1 has a function that allows the setting contents of each audio device 2 to be individually changed. Specific examples (Examples 1 to 5) of a configuration for realizing the function will be described below.

### Example 1

In the audio processing apparatus 1 according to Example 1, the setting processing unit 116 sets mute for a predetermined audio device 2. Specifically, the setting processing unit 116 sets whether to erase, block or stop (mute) the output to the outside (whether to enable or disable the mute function) for the sound input from the predetermined audio device 2. For example, when the acquisition processing unit 111 acquires a specific sound input to a microphone of the audio device 2A from the audio device 2A, the setting processing unit 116 sets the microphone of the audio device 2A to mute (enables a mute function). As a result, audio (for example, uttered audio of user A) input from the microphone of the audio device 2A is erased. For example, in a case where the user A wearing the audio device 2A taps the microphone of the audio device 2A two consecutive times with a finger, two consecutive tapping sounds are input to the microphone of the audio device 2A. In a case where the acquisition processing unit 111 determines that audio acquired from the audio device 2A is two consecutive tapping sounds, the setting processing unit 116 sets the microphone of the audio device 2A to mute.

FIG. 5 illustrates an example of a procedure of audio control processing executed by the controller 11 of the audio processing apparatus 1 according to Example 1.

Note that the disclosure can be regarded as an audio control method (the audio processing method of the disclosure) that executes one or more steps included in the audio control processing. In addition, the one or more steps included in the audio control processing described herein may be omitted as appropriate. Further, the steps of the audio control processing may be executed in a different order to the extent that similar effects are obtained. Furthermore, here, a case where the controller 11 executes each step in the audio control processing will be described as an example, but in another embodiment, one or more processors may execute respective steps in the audio control processing in a distributed manner. The same applies to the audio control processing in Examples 2 to 5 described below.

First, in step S11, the controller 11 (setting processing unit 116) determines whether audio has been input to a microphone of any of the audio devices 2. That is, the controller 11 determines whether input sound input to a microphone has been acquired from any of the audio devices 2. In a case where the controller 11 acquires input sound (S11: Yes), it shifts the processing to step S12. The controller 11 waits until input sound is acquired (S11: No).

In step S12, the controller 11 (setting processing unit 116) detects a waveform of the input sound.

In step S13, the controller 11 (the setting processing unit 116) determines whether the detected waveform of the input sound matches a registered waveform registered in advance (a registered waveform corresponding to mute).

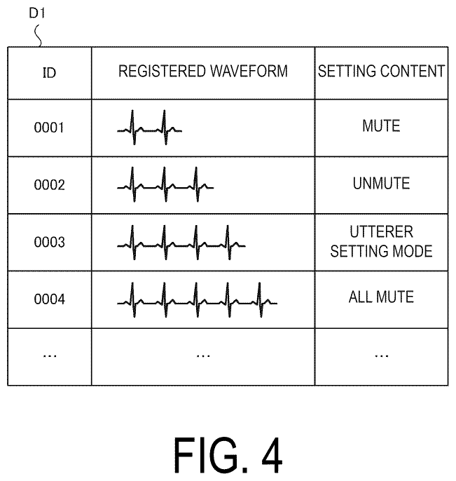

Here, the storage 12 stores a setting information registration list D1. FIG. 4 illustrates an example of the setting information registration list D1. In the setting information registration list D1, a waveform of a predetermined sound (a registered waveform) and a setting content of the audio device 2 are registered in association with each other. For example, ID “0001” is registered in association with a waveform representing two consecutive tapping sounds and a setting content of mute. ID “0002” is registered in association with a waveform representing three consecutive tapping sounds and a setting content of unmute (see Example 2 described below). ID “0003” is registered in association with a waveform representing four consecutive tapping sounds and a setting content of an utterer setting mode (see Examples 3 and 5 described below). ID “0004” is registered in association with a waveform representing five consecutive tapping sounds and a setting content of all mute (see Example 4 described below). For example, an administrator of the audio device 2 registers in advance a combination of a registered waveform and a setting content. The registered contents of the setting information registration list D1 may be notified to each user of the audio device 2.

In step S13, the controller 11 determines whether a detected waveform of the input sound matches a waveform corresponding to two consecutive tapping sounds (a registered waveform corresponding to mute) registered in the setting information registration list D1. When the controller 11 determines that the detected waveform of the input sound matches the waveform corresponding to the two consecutive tapping sounds (S13: Yes), it shifts the processing to step S14. On the other hand, when the controller 11 determines that the detected waveform of the input sound does not match the waveform corresponding to the two consecutive tapping sounds (S13: No), it shifts the processing to step S11.

In step S14, the controller 11 (setting processing unit 116) sets the microphone of the audio device 2 that has acquired the input sound to mute. For example, in a case where the user A of the audio device 2A taps the microphone of the audio device 2A two consecutive times with a finger, the controller 11 sets the microphone of the audio device 2A to mute. In this case, the controller 11 does not change the settings of the microphones of the other audio devices 2B to 2D. In a case where the user B of the audio device 2B taps the microphone of the audio device 2B two consecutive times with a finger, the controller 11 sets the microphone of the audio device 2B to mute. In this manner, the controller 11 can individually set the mute according to the operation of the user for each audio device 2.

In addition, in a case where the controller 11 (the setting processing unit 116) changes a setting content of a predetermined setting item of the audio device 2, it notifies by sound that the setting content has been changed. For example, in a case where the controller 11 sets a microphone of the audio device 2A to mute, it causes a speaker of the audio device 2A to output information (such as audio) indicating that the microphone has been set to mute. In this case, the controller 11 does not cause the speakers of the other audio devices 2B to 2D to output the information indicating that the microphone of the audio device 2A is set to mute.

In addition, in a case where the input sound is a registered sound registered in the setting information registration list D1, the controller 11 (audio output processing unit 114) does not output the input sound to an external device. For example, the controller 11 cancels two consecutive tapping sounds input to a microphone of the audio device 2A by a noise canceller and does not output the two consecutive tapping sounds to the conference terminal 3 and the respective audio devices 2. As a result, for example, it is possible to prevent unnecessary sounds for the conference (tapping sounds) from being played back to the other party of the conference (the conference room R2).

### Example 2

In the audio processing apparatus 1 according to Example 2, the setting processing unit 116 unmutes the predetermined audio device 2. For example, in a case where the acquisition processing unit 111 acquires a specific sound input to a microphone of the audio device 2A from the audio device 2A, the setting processing unit 116 unmutes the microphone of the audio device 2A (sets a mute function to be disabled). For example, in a case where the user A wearing the audio device 2A set to mute taps the microphone of the audio device 2A three consecutive times with a finger, the three consecutive tapping sounds are input to the microphone of the audio device 2A. In a case where it is determined that audio acquired from the audio device 2A by the acquisition processing unit 111 is three consecutive tapping sounds, the setting processing unit 116 unmutes a microphone of the audio device 2A.

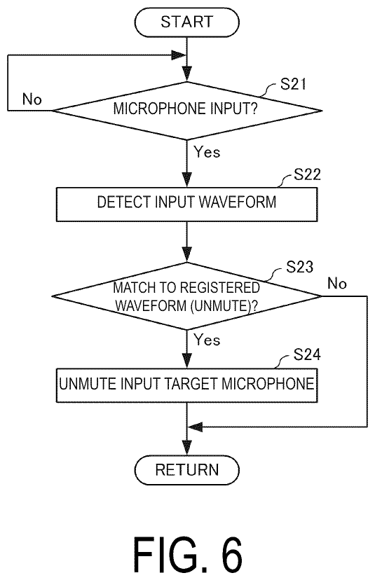

FIG. 6 illustrates an example of a procedure of audio control processing executed by the controller 11 of the audio processing apparatus 1 according to Example 2.

First, in step S21, the controller 11 (setting processing unit 116) determines whether audio has been input to a microphone of any of the audio devices 2. That is, the controller 11 determines whether input sound input to a microphone has been acquired from any of the audio devices 2. In a case where the controller 11 acquires input sound (S21: Yes), it shifts the processing to step S22. The controller 11 waits until input sound is acquired (S21: No).

In step S22, the controller 11 (the setting processing unit 116) detects a waveform of the input sound.

In step S23, the controller 11 (the setting processing unit 116) determines whether the detected waveform of the input sound matches a registered waveform registered in advance (a registered waveform corresponding to unmute).

Specifically, the controller 11 determines whether the detected waveform of the input sound matches a waveform corresponding to three consecutive tapping sounds (a registered waveform corresponding to unmute) registered in the setting information registration list D1 (see FIG. 4). When the controller 11 determines that the detected waveform of the input sound matches the waveform corresponding to the three consecutive tapping sounds (S23: Yes), it shifts the processing to step S24. On the other hand, when the controller 11 determines that the detected waveform of the input sound does not match the waveform corresponding to the three consecutive tapping sounds (S23: No), it shifts the processing to step S21.

In step S24, the controller 11 (setting processing unit 116) unmutes the microphone of the audio device 2 that has acquired the input sound. For example, in a case where the user A of the audio device 2A taps the microphone of the audio device 2A three consecutive times with a finger, the controller 11 unmutes the microphone of the audio device 2A. In this case, the controller 11 does not change the settings of the microphones of the other audio devices 2B to 2D. In a case where the user B of the audio device 2B whose microphone has been set to mute taps the microphone of the audio device 2B three consecutive times with a finger, the controller 11 unmutes the microphone of the audio device 2B. In this manner, the controller 11 can individually unmute according to the operation of the user for each audio device 2.

Further, similar to Example 1, in a case where the controller 11 unmutes the microphone of the audio device 2A, it causes the speaker of the audio device 2A to output information (such as audio) indicating that the microphone has been unmuted, and does not cause the speakers of the other audio devices 2B to 2D to output the information. In addition, the controller 11 cancels the three consecutive tapping sounds input to the microphone of the audio device 2A by the noise canceller and does not output the tapping sounds to the conference terminal 3 and the audio devices 2.

### Example 3

In the audio processing apparatus 1 according to Example 3, the setting processing unit 116 causes a predetermined audio device 2 to transition to an utterer setting mode, and assigns a user name of the audio device 2 (microphone) in the utterer setting mode. For example, in a case where the acquisition processing unit 111 acquires a specific sound input to a microphone of the audio device 2A from the audio device 2A, the setting processing unit 116 shifts the audio device 2A to the utterer setting mode. For example, in a case where the user A wearing the audio device 2A taps the microphone of the audio device 2A four consecutive times with a finger, four consecutive tapping sounds are input to the microphone of the audio device 2A. In a case where it is determined that audio acquired from the audio device 2A by the acquisition processing unit 111 is four consecutive tapping sounds, the setting processing unit 116 shifts the audio device 2A to the utterer setting mode.

Further, in the utterer setting mode, the setting processing unit 116 sets a user name to be assigned to a microphone of the audio device 2. The assigned user name is displayed in association with the text when, for example, displaying audio-recognized text. Specifically, after shifting to the utterer setting mode, the setting processing unit 116 sets text of uttered audio acquired from the audio device 2A by the acquisition processing unit 111 as a user name of the audio device 2A.

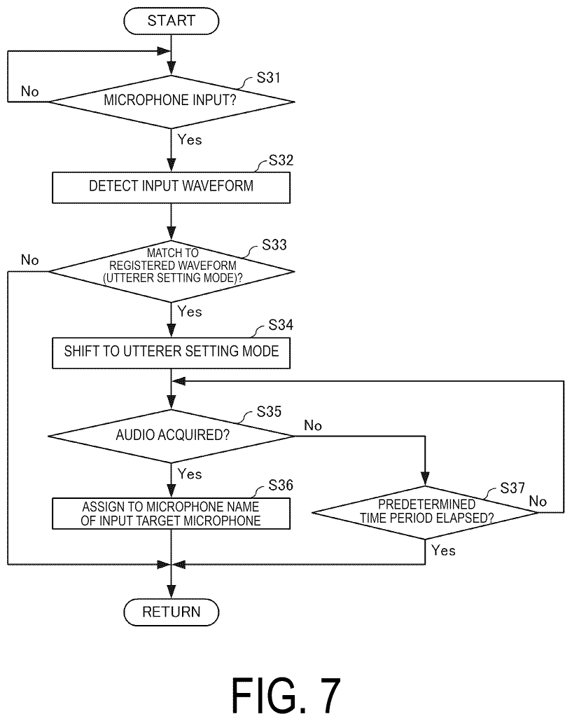

FIG. 7 illustrates an example of a procedure of audio control processing executed by the controller 11 of the audio processing apparatus 1 according to Example 3.

First, in step S31, the controller 11 (setting processing unit 116) determines whether audio has been input to a microphone of any of the audio devices 2. That is, the controller 11 determines whether input sound input to a microphone has been acquired from any of the audio devices 2. In a case where the controller 11 acquires input sound (S31: Yes), it shifts the processing to step S32. The controller 11 waits until input sound is acquired (S31: No).

In step S32, the controller 11 (the setting processing unit 116) detects a waveform of the input sound.

In step S33, the controller 11 (the setting processing unit 116) determines whether the detected waveform of the input sound matches a registered waveform registered in advance (a registered waveform corresponding to the utterer setting mode).

Specifically, the controller 11 determines whether the detected waveform of the input sound matches a waveform corresponding to four consecutive tapping sounds (a registered waveform corresponding to the utterer setting mode) registered in the setting information registration list D1 (see FIG. 4). When the controller 11 determines that the detected waveform of the input sound matches the waveform corresponding to the four consecutive tapping sounds (S33: Yes), it shifts the processing to step S34. On the other hand, when the controller 11 determines that the detected waveform of the input sound does not match the waveform corresponding to the four consecutive tapping sounds (S33: No), it shifts the processing to step S31.

In step S34, the controller 11 (setting processing unit 116) shifts the audio device 2 that has acquired the input sound to the utterer setting mode. For example, in a case where the user A of the audio device 2A taps the microphone of the audio device 2A four consecutive times with a finger, the controller 11 shifts the audio device 2A to the utterer setting mode. In this case, the controller 11 does not change the settings of the other audio devices 2B to 2D. In a case where the user B of the audio device 2B taps the microphone of the audio device 2B four consecutive times with a finger, the controller 11 shifts the audio device 2B to the utterer setting mode. In this manner, the controller 11 can individually shift the utterer setting mode according to the operation of the user for each audio device 2.

Further, similar to Example 1, in a case where the controller 11 shifts the audio device 2A to the utterer setting mode, it causes the audio device 2A to output information (such as audio) indicating that the audio device 2A has been shifted to the utterer setting mode, and does not cause speakers of the other audio devices 2B to 2D to output the information. In addition, the controller 11 cancels the four consecutive tapping sounds input to the microphone of the audio device 2A by the noise canceller and does not output the tapping sounds to the conference terminal 3 and the audio devices 2.

In step S35, the controller 11 (setting processing unit 116) determines whether audio has been acquired from the audio device 2A in the utterer setting mode. Specifically, in a case where the controller 11 acquires uttered audio input to a microphone of the audio device 2A within a predetermined time (S35: Yes, S37: No), it shifts the processing to step S36. On the other hand, in a case where the controller 11 does not acquire uttered audio from the audio device 2A within a predetermined time (S35: No, S37: Yes), that is, in a case where the predetermined time has elapsed without acquiring uttered audio, it cancels the utterer setting mode and shifts the processing to step S31.

In step S36, the controller 11 (setting processing unit 116) assigns the text of the uttered audio as a user name to the audio device 2A that has shifted to the utterer setting mode. For example, in the utterer setting mode, in a case where the user A of the audio device 2A utters “TANAKA”, the controller 11 assigns “TANAKA” to the audio device 2A.

The utterer setting mode is executed sequentially in each of the audio devices 2, for example, before the start of a conference. For example, after the user A registers the user name of the audio device 2A, when the user B taps the microphone of the audio device 2B four consecutive times with a finger to shift it to the utterer setting mode and, the user B makes an utterance “SUZUKI” after shifting to the utterer setting mode, the controller 11 assigns “SUZUKI” to the audio device 2B. Similarly, the controller 11 assigns user names to the audio devices 2C and 2D.

When the assignment of the user name is completed and the conference is conducted, the name of each user is associated with the text obtained by audio recognition of the audio uttered by the user.

### Example 4

In the audio processing apparatus 1 according to Example 4, the setting processing unit 116 sets mute of all the audio devices 2. For example, in a case where the acquisition processing unit 111 acquires a specific sound input to the microphone of the audio device 2 from any of the audio devices 2, the setting processing unit 116 sets the microphones of all the audio devices 2 to mute (enables the mute function). Thus, the audio input from the microphones of all the audio devices 2 are erased. For example, in a case where the user D wearing the audio device 2D taps the microphone of the audio device 2D five consecutive times with a finger, five consecutive tapping sounds are input to the microphone of the audio device 2D. In a case where the acquisition processing unit 111 determines that the sound acquired from the audio device 2D is the five consecutive tapping sounds, the setting processing unit 116 sets the microphones of the audio devices 2A to 2D to mute.

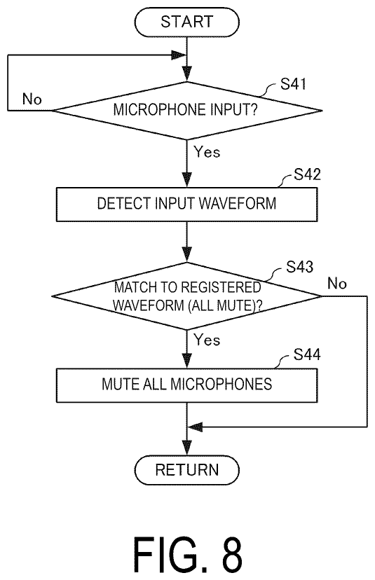

FIG. 8 illustrates an example of a procedure of audio control processing executed by the controller 11 of the audio processing apparatus 1 according to Example 4.

First, in step S41, the controller 11 (setting processing unit 116) determines whether audio has been input to a microphone of any of the audio devices 2. That is, the controller 11 determines whether input sound input to a microphone has been acquired from any of the audio devices 2. In a case where the controller 11 acquires input sound (S41: Yes), it shifts the processing to step S42. The controller 11 waits until input sound is acquired (S41: No).

In step S42, the controller 11 (the setting processing unit 116) detects a waveform of the input sound.

In step S43, the controller 11 (the setting processing unit 116) determines whether the detected waveform of the input sound matches a registered waveform that has been registered in advance (the registered waveform corresponding to all mute).

Specifically, the controller 11 determines whether the detected waveform of the input sound matches a waveform corresponding to five consecutive tapping sounds (a registered waveform corresponding to all mute) registered in the setting information registration list D1 (see FIG. 4). When the controller 11 determines that the detected waveform of the input sound matches the waveform corresponding to the five consecutive tapping sounds (S43: Yes), it shifts the processing to step S44. On the other hand, when the controller 11 determines that the detected waveform of the input sound does not match the waveform corresponding to the five consecutive tapping sounds (S43: No), it shifts the processing to step S41.

In step S44, the controller 11 (setting processing unit 116) sets the microphones of all the audio devices 2 to mute. For example, in a case where the user D of the audio device 2D taps the microphone of the audio device 2D five consecutive times with a finger, the controller 11 sets all the microphones of the audio devices 2A to 2D to mute. In this manner, the controller 11 can set all of the audio devices 2 to mute collectively.

For example, when the user of any one of the audio devices 2 taps the microphone of the audio device 2 six consecutive times with a finger, the controller 11 may unmute the microphones of all the audio devices 2. In this manner, the controller 11 may collectively unmute all the audio devices 2.

### Example 5

In the audio processing apparatus 1 according to Example 5, the setting processing unit 116 causes a predetermined audio device 2 to transition to the utterer setting mode, and assigns a user name of the audio device 2 (microphone) in the utterer setting mode. Example 5 is a modification example of Example 3. For example, in a case where the acquisition processing unit 111 acquires a specific sound input to a microphone of the audio device 2A from the audio device 2A, the setting processing unit 116 shifts the audio device 2A to the utterer setting mode. For example, in a case where the user A wearing the audio device 2A taps the microphone of the audio device 2A four consecutive times with a finger, four consecutive tapping sounds are input to the microphone of the audio device 2A. In a case where it is determined that audio acquired from the audio device 2A by the acquisition processing unit 111 is four consecutive tapping sounds, the setting processing unit 116 shifts the audio device 2A to the utterer setting mode.

In the utterer setting mode, the setting processing unit 116 sets the user name to be assigned to the microphone of the audio device 2 based on tapping sounds applied to the audio device 2. Specifically, after shifting to the utterer setting mode, when the acquisition processing unit 111 acquires a predetermined tapping sound from the audio device 2A, the setting processing unit 116 sets, as the user name of the audio device 2A, the user name that has been previously associated with the tapping sound.

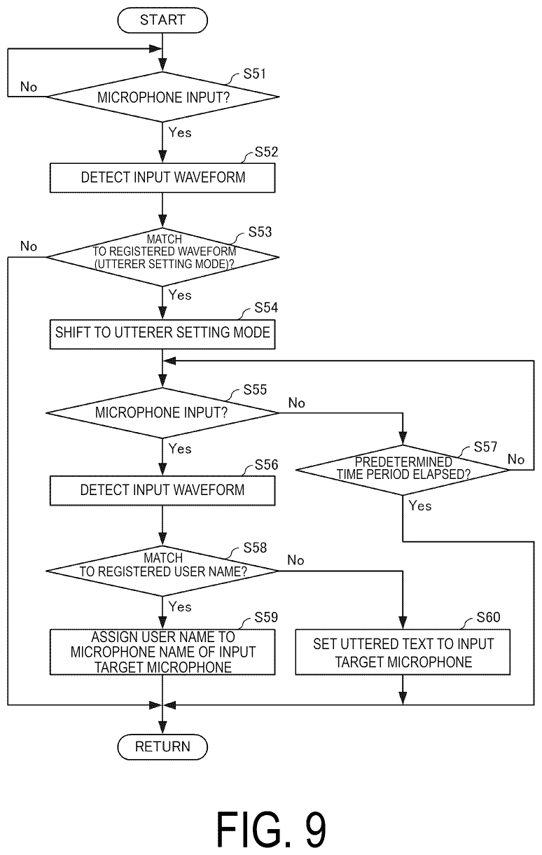

FIG. 9 illustrates an example of a procedure of audio control processing executed by the controller 11 of the audio processing apparatus 1 according to Example 5.

First, in step S51, the controller 11 (setting processing unit 116) determines whether audio has been input to a microphone of any of the audio devices 2. That is, the controller 11 determines whether input sound input to a microphone has been acquired from any of the audio devices 2. In a case where the controller 11 acquires input sound (S51: Yes), it shifts the processing to step S52. The controller 11 waits until input sound is acquired (S51: No).

In step S52, the controller 11 (the setting processing unit 116) detects a waveform of the input sound.

In step S53, the controller 11 (the setting processing unit 116) determines whether the detected waveform of the input sound matches a registered waveform registered in advance (a registered waveform corresponding to the utterer setting mode).

Specifically, the controller 11 determines whether the detected waveform of the input sound matches a waveform corresponding to four consecutive tapping sounds (a registered waveform corresponding to the utterer setting mode) registered in the setting information registration list D1 (see FIG. 4). When the controller 11 determines that the detected waveform of the input sound matches the waveform corresponding to the four consecutive tapping sounds (S53: Yes), it shifts the processing to step S54. On the other hand, when the controller 11 determines that the detected waveform of the input sound does not match the waveform corresponding to the four consecutive tapping sounds (S53: No), it shifts the processing to step S51.

In step S54, the controller 11 (setting processing unit 116) shifts the audio device 2 that has acquired the input sound to the utterer setting mode. For example, in a case where the user A of the audio device 2A taps the microphone of the audio device 2A four consecutive times with a finger, the controller 11 shifts the audio device 2A to the utterer setting mode. In this case, the controller 11 does not change the settings of the other audio devices 2B to 2D. In a case where the user B of the audio device 2B taps the microphone of the audio device 2B four consecutive times with a finger, the controller 11 shifts the audio device 2B to the utterer setting mode. In this manner, the controller 11 can individually shift the utterer setting mode according to the operation of the user for each audio device 2.

Further, similar to Example 1, in a case where the controller 11 shifts the audio device 2A to the utterer setting mode, it causes the audio device 2A to output information (such as audio) indicating that the audio device 2A has been shifted to the utterer setting mode, and does not cause speakers of the other audio devices 2B to 2D to output the information. In addition, the controller 11 cancels the four consecutive tapping sounds input to the microphone of the audio device 2A by the noise canceller and does not output the tapping sounds to the conference terminal 3 and the audio devices 2.

In step S55, the controller 11 (setting processing unit 116) determines whether sound has been input to the microphone of the audio device 2A in the utterer setting mode. Specifically, in a case where the controller 11 acquires input sound input to the microphone of the audio device 2A within a predetermined time (S55: Yes, S57: No), it shifts the processing to step S56. On the other hand, in a case where the controller 11 does not acquire input sound from the audio device 2A within a predetermined time (S55: No, S57: Yes), it cancels the utterer setting mode and shifts the processing to step S51.

In step S56, the controller 11 (setting processing unit 116) detects a waveform of the input sound.

In step S58, the controller 11 (the setting processing unit 116) determines whether the detected waveform of the input sound matches a registered waveform registered in advance (a registered waveform corresponding to a user name).

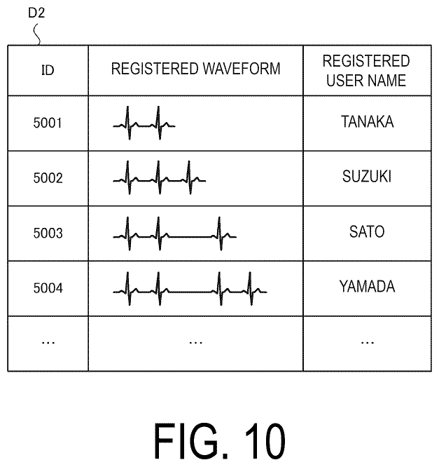

Here, the storage 12 stores a user information registration list D2. FIG. 10 is an example of the user information registration list D2. In the user information registration list D2, a waveform (registered waveform) of a predetermined sound and a user name are registered in association with each other. For example, ID “5001” is registered in association with a waveform representing two consecutive tapping sounds and the user name “TANAKA”. ID “5002” is registered in association with a waveform representing three consecutive tapping sounds and the user name “SUZUKI”. ID “5003” is registered in association with a waveform representing two consecutive tapping sounds followed, after a predetermined interval, by one tapping sound, and the user name “SATO”. ID “5004” is registered in association with a waveform representing two consecutive tapping sounds followed, after a predetermined interval, by another two consecutive tapping sounds, and the user name “YAMADA”. For example, an administrator of the audio device 2 registers in advance a combination of a registered waveform and a user name. The registered contents of the user information registration list D2 may be notified to each user of the audio device 2.

In step S58, the controller 11 determines whether the detected waveform of the input sound matches a waveform (registered waveform) registered in the user information registration list D2. When the controller 11 determines that the detected waveform of the input sound matches the registered waveform (S58: Yes), it shifts the processing to step S59. On the other hand, when the controller 11 determines that the detected waveform of the input sound does not match the registered waveform (S58: No), it shifts the processing to step S60.

In step S59, the controller 11 (setting processing unit 116) assigns, to the audio device 2A in the utterer setting mode, the user name associated with the registered waveform that matches the detected waveform of the input sound. For example, in the utterer setting mode, when the user A of the audio device 2A taps the microphone of the audio device 2A two consecutive times with a finger, the controller 11 assigns “TANAKA” to the audio device 2A.

The utterer setting mode is executed sequentially in each of the audio devices 2, for example, before the start of a conference. For example, after the user A registers the user name of the audio device 2A, the user B taps the microphone of the audio device 2B four consecutive times with a finger to shift it to the utterer setting mode, and after shifting to the utterer setting mode, taps the microphone of the audio device 2B three consecutive times with a finger, the controller 11 assigns “SUZUKI” to the audio device 2B. Similarly, the controller 11 assigns user names to the audio devices 2C and 2D.

When the assignment of the user name is completed and the conference is conducted, the name of each user is associated with the text obtained by audio recognition of the audio uttered by the user.

The audio processing apparatus 1 executes the audio control processing of Examples 1 to 5 as described above. The audio processing apparatus 1 may include any one of the configurations of Examples 1 to 5, or may include at least two of the configurations of Examples 1 to 5. The audio processing apparatus 1 can execute audio control processing in which all of Example 1 to Example 5 are combined by storing the setting information registration list D1 illustrated in FIG. 4 and the user information registration list D2 illustrated in FIG. 10.

As described above, the audio processing system 100 according to the present disclosure is a system that acquires input sounds input to respective microphones of a plurality of audio devices 2 and executes predetermined audio processing. In the audio processing system 100, the audio processing apparatus 1 acquires input sound that input to the microphone of a first audio device 2 among the plurality of audio devices 2, and, in a case where the acquired input sound is a registered sound that has been registered in advance (see FIG. 4), changes the setting content of a predetermined setting item of the first audio device 2 to the setting content that has been registered in advance in association with the registered sound (see FIG. 4). In addition, the audio processing apparatus 1 does not change the setting content of a predetermined setting item of the other audio devices 2 among the plurality of audio devices 2 excluding the first audio device 2.

For example, the audio processing apparatus 1 refers to a storage 12 (setting information registration list D1) that stores a waveform of a predetermined sound and setting content in association with each other in advance, and, when a waveform matching the acquired input sound waveform is stored, changes the setting content of the predetermined setting item of the first audio device 2 to the setting content associated with the waveform.

According to the above configuration, it is possible to individually change the settings of the audio device 2 in the audio processing apparatus 1 without performing a setting change operation on the audio device 2. Therefore, for example, even in a case where a conference is held using a mixture of general-purpose audio devices 2 of different types, each audio device 2 can have its settings changed individually. Therefore, the convenience of the audio device 2 can be improved.

In addition, the audio processing apparatus 1 may, in a case where the setting content of a predetermined setting item of the first audio device 2 has been changed, notify by sound that the setting content has been changed. For example, the audio processing apparatus 1 may be configured to output, from the speaker of the first audio device 2, information indicating that the setting content has been changed, and not to output it from the speakers of the other audio devices 2.

In addition, in a case where the audio processing apparatus 1 has a configuration to output the acquired input sound to an external device (such as a conference terminal 3), it may be configured not to output the input sound to the external device when the input sound is the registered sound. Accordingly, it is possible to prevent input sounds (such as tapping sounds) for setting changes from being played back to the outside (to the other party in the conference).

The input sound is, for example, a tapping sound on the microphone, but is not limited thereto, and may be a blowing sound directed into the microphone or a rubbing sound against the microphone. The input sound may also be the user's uttered audio (for example, uttered audio such as “mute setting” or “unmute”).

The predetermined setting item may be, for example, mute, unmute, or utterer setting mode of the microphone, but is not limited thereto, and may also be volume (high/low) settings of playback sound reproduced (output) by the audio device 2, frequency (high/low) settings of playback sound reproduced (output) by the audio device 2, or inquiries about the remaining battery level of the audio device 2.

In the embodiment described above, an example has been shown in which the conference room R1 and the conference room R2 are connected via a network to hold an online conference. However, the audio processing system 100 of the disclosure may be configured with only a single conference room R1. In this case, for example, in the conference room R1, the conference terminal 3 causes audio input to the microphone of one audio device 2 to be reproduced from the speaker of another audio device 2, and also causes text information obtained by converting the audio to be displayed on the display device 5. For example, the audio output processing unit 114 may output, from the speaker of the audio device 2, the audio after the audio processing by the audio processing unit 112, and the text output processing unit 115 may display, on the display device 5, the text information that is the recognition result of the audio recognition processing by the audio recognition processing unit 113.

Note that the controller 11 of the audio processing apparatus 1 controls the entire audio processing apparatus 1. The controller 11 realizes various functions by reading and executing various programs stored in the storage 12 (for example, storage or ROM). The controller 11 may be implemented by one or more control devices/arithmetic devices (such as a central processing unit (CPU), and a system on a chip (SoC)). In addition, the controller 11 may include one or more control circuits (electronic circuits).

### Supplements of Disclosure

Hereinafter, an outline of the disclosure extracted from the above-described embodiments will be described as supplementary notes. Configurations and processing functions described in the following supplements can be selected and combined as desired.

### Supplement 1

An audio processing system that acquires input sounds input to respective microphones of a plurality of audio devices and executes predetermined audio processing, the audio processing system including

an acquisition processing circuit that acquires an input sound input to a microphone of a first audio device among the plurality of audio devices, and
a setting processing circuit that, in a case where the input sound acquired by the acquisition processing circuit is a registered sound registered in advance, changes a setting content of a predetermined setting item of the first audio device to the setting content registered in advance in association with the registered sound, and does not change the setting content of the predetermined setting item of a different audio device among the plurality of audio devices excluding the first audio device.

### Supplement 2

The audio processing system according to Supplement 1, in which, in a case where the setting content of the predetermined setting item of the first audio device is changed, the setting processing circuit notifies by sound that the setting content has been changed.

### Supplement 3

The audio processing system according to claim 2, in which the setting processing circuit causes information indicating that the setting content has been changed to be output from a speaker of the first audio device and not to be output from a speaker of the different audio device.

### Supplement 4

The audio processing system according to any one of Supplement 1 to Supplement 3, including

an output processing circuit that outputs the input sound acquired by the acquisition processing circuit to an external device, in which
the output processing circuit does not output the input sound to the external device in a case where the input sound acquired by the acquisition processing circuit is the registered sound.

### Supplement 5

The audio processing system according to any one of Supplement 1 to Supplement 4, in which the input sound is a tapping sound on the microphone.

### Supplement 6

The audio processing system according to any one of Supplement 1 to Supplement 5, in which the predetermined setting item is muting or unmuting of the microphone.

### Supplement 7

The audio processing system according to any one of Supplement 1 to Supplement 6, in which the predetermined setting item is registration of a user name of the first audio device.

### Supplement 8

The audio processing system according to any one of Supplement 1 to Supplement 7, in which the setting processing circuit refers to a storage that stores a waveform of a predetermined sound and setting content in association with each other in advance, and in a case where a waveform matching a waveform of the input sound acquired by the acquisition processing circuit is stored in the storage, the setting processing circuit changes the setting content of the predetermined setting item of the first audio device to the setting content associated with the waveform.

### Supplement 9

An audio processing method of acquiring input sounds input to respective microphones of a plurality of audio devices and executing predetermined audio processing, the audio processing method being executed by one or more processors, the audio processing method including

acquiring an input sound input to a microphone of a first audio device among the plurality of audio devices, and
in a case where the acquired input sound is a registered sound registered in advance, changing a setting content of a predetermined setting item of the first audio device to a setting content registered in advance in association with the registered sound, and not changing a setting content of the predetermined setting item of a different audio device among the plurality of audio devices excluding the first audio device.

### Supplement 10

An audio processing program that acquires input sounds input to respective microphones of a plurality of audio devices and executes predetermined audio processing,

the audio processing program causing one or more processors to execute acquiring an input sound input to a microphone of a first audio device among the plurality of audio devices, and
in a case where the acquired input sound is a registered sound registered in advance, changing a setting content of a predetermined setting item of the first audio device to a setting content registered in advance in association with the registered sound, and not changing a setting content of the predetermined setting item of a different audio devices among the plurality of audio devices excluding the first audio device, or
a non-transitory computer-readable recording medium storing the audio processing program.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An audio processing system comprising one or more processors, the audio processing system acquiring input sounds input to respective microphones of a plurality of audio devices and executing predetermined audio processing, wherein
the one or more processors
acquire an input sound input to a microphone of a first audio device among the plurality of audio devices, and
in a case where the acquired input sound is a registered sound registered in advance, change a setting content of a predetermined setting item of the first audio device to a setting content registered in advance in association with the registered sound, and do not change a setting content of the predetermined setting item of a different audio device among the plurality of audio devices excluding the first audio device.

2. The audio processing system according to claim 1, wherein
in a case where the setting content of the predetermined setting item of the first audio device is changed, the one or more processors notify by sound that the setting content has been changed.

3. The audio processing system according to claim 2, wherein
the one or more processors cause information indicating that the setting content has been changed to be output from a speaker of the first audio device and not to be output from a speaker of the different audio device.

4. The audio processing system according to claim 1, wherein
in a case where the acquired input sound is the registered sound, the one or more processors do not output the input sound to an external device.

5. The audio processing system according to claim 1, wherein
the input sound is a tapping sound on the microphone.

6. The audio processing system according to claim 1, wherein
the predetermined setting item is muting or unmuting of the microphone.

7. The audio processing system according to claim 1, wherein
the predetermined setting item is registration of a user name of the first audio device.

8. The audio processing system according to claim 1, wherein
the one or more processors refer to a storage that stores a waveform of a predetermined sound and a setting content in association with each other in advance, and in a case where a waveform that matches the acquired waveform of the input sound is stored in the storage, the one or more processors change the setting content of the predetermined setting item of the first audio device to the setting content associated with the waveform.

9. An audio processing method of acquiring input sounds input to respective microphones of a plurality of audio devices and executing predetermined audio processing,
the audio processing method being executed by one or more processors,
the audio processing method comprising:
acquiring an input sound input to a microphone of a first audio device among the plurality of audio devices; and
in a case where the acquired input sound is a registered sound registered in advance, changing a setting content of a predetermined setting item of the first audio device to a setting content registered in advance in association with the registered sound, and not changing a setting content of the predetermined setting item of a different audio device among the plurality of audio devices excluding the first audio device.

10. A non-transitory computer-readable recording medium storing an audio processing program that acquires input sounds input to respective microphones of a plurality of audio devices and executes predetermined audio processing,
the audio processing program causing one or more processors to execute:
acquiring an input sound input to a microphone of a first audio device among the plurality of audio devices; and
in a case where the acquired input sound is a registered sound registered in advance, changing a setting content of a predetermined setting item of the first audio device to a setting content registered in advance in association with the registered sound, and not changing a setting content of the predetermined setting item of a different audio device among the plurality of audio devices excluding the first audio device.
